(19) United States
(12) Patent Application Publication
(10) Pub. No.: US 2008/0235357 A1
(43) Pub. Date: Sep. 25, 2008

(54) ON-LINE CONFIGURATION MANAGEMENT SYSTEM AND METHOD

(76) Inventor: Daniel Gustafsson, Alvangen (SE)

Correspondence Address: ERICSSON INC., 6300 LEGACY DRIVE, M/S EVR 1-C-11, PLANO, TX, 75024, US

(21) Appl. No.: 12/038,092

(22) Filed: Feb. 27, 2008

Related U.S. Application Data
(60) Provisional application No. 60/896,295, filed on Mar. 22, 2007.

(51) Int. Cl. G06F 15/177; G06F 9/445; G06F 13/00

(52) U.S. Cl. 709/220; 717/177; 719/318

(57) ABSTRACT

A system and method for on-line configuration management of a production environment having a plurality of target nodes, each of which has a current configuration of software controlling at least some of the functions of the node. The system includes a central configuration management server, a plurality of agents associated with the target nodes, and a central configuration database in communication with the central server. Each agent is installed on an associated target node to monitor the configuration of the software on the associated node and to report to the server, configuration changes detected by the agent. The central configuration database stores the configuration of the software as reported by the agents for the plurality of nodes.

### CROSS-REFERENCE TO RELATED APPLICATIONS

This application claims the benefit of U.S. Provisional Application No. 60/896,295, filed Mar. 22, 2007, the disclosure of which is incorporated herein by reference.

### STATEMENT REGARDING FEDERALLY SPONSORED RESEARCH OR DEVELOPMENT

NOT APPLICABLE

### REFERENCE TO SEQUENCE LISTING, A TABLE, OR A COMPUTER PROGRAM LISTING COMPACT DISC APPENDIX

NOT APPLICABLE

### BACKGROUND

The present invention relates to configuration management (CM) tools. More particularly, and not by way of limitation, the present invention is directed to a system and method for on-line configuration management for telecommunication production environments.

The need for CM tools in telecommunication production environments has grown extensively in recent years, especially since the introduction of mobile value added services. For operators, new services and telecommunication system integration solutions are always in development.

Due to market demands, most telecommunication system integration solutions are deployed before their software is ready and are constantly being improved during operation. This causes major problems for telecommunication operators because of the heavy maintenance processes required to keep track of the different revisions and configurations. Some operators, for example, may have mobile service delivery solutions running as many as 3,000 services on server platforms consisting of approximately 300 nodes. The software on these nodes needs to be updated and modified according to market needs every time an offering is changed or a new service is introduced. In addition, the operators have to handle normal application maintenance such as patches and upgrades of the platforms.

Operators have attempted to overcome this problem by extensively testing new software in a simulated laboratory environment before deploying the software in the real world. The problem with this approach is that even with strict manual processes in place the simulated laboratory environment is often different from the real world, thus leading to unforeseen problems when the software is introduced in the real world.

However, even automated solutions for configuration management have limitations. The existing CM products in this area are most commonly off-line tools, meaning that even if they are automated, they are only updated at scheduled times through non-configurable auto-discovery protocols. The disadvantages with existing off-line/auto-discovery CM tools include:

Changes performed between scheduled runs are not detected.

IP-based auto-discovery is often not capable of handling revisions of individual configuration files because there is no intelligence on the nodes.

The tools may loose history/traceability if the IP addresses are changed.

The tools require central updates through huge scheduled batch runs.

There is a significant difference between a real CM tool with proper revision handling of all files in an application and the existing auto-discovery products that mainly are built for inventory management. These tools will only report the revision of installed applications and do not keep revision handling of customized configuration files.

### SUMMARY

The present invention provides an automated on-Line CM tool for revision handling that overcomes the disadvantages of the prior art. In one embodiment, the tool keeps track of software versions and applications in large production and development environments. The present invention may also be described as a soft real-time CM tool or system for keeping a number of connected systems up to date with changing situations.

The present invention provides many advantages over prior art manual CM systems and off-line automated CM systems. The present invention automatically records in a central CM database, changes made on any of a plurality of target nodes. Easily configurable, intelligent agents are installed in the target nodes to continuously monitor the target nodes and immediately report any configuration changes to the central CM database. The dependency on manual intervention is thus eliminated, thereby enabling operators to apply strictly process-driven development behavior while relieving the operator of the heavy maintenance and manual processes required by prior art systems. The process also greatly reduces bandwidth requirements by eliminating the need for large batch runs to update the system.

Real-time automated reporting of configuration changes ensures the CM system reflects the real environment at all times. A central CM server provides CM maintenance personal with the ability to instantly verify that the target nodes are running on the correct software versions. Additionally, if an unauthorized modification is made on any target node, the agent for that node immediately detects the modification and reports it to the central CM database. A version handler stores in memory all versions that have existed on the target nodes. This provides CM maintenance personnel with the ability to quickly revert to a previous version if required. The system also provides automatic event forwarding to a fault management (FM) system when changes are detected. The system can also centrally push the best working configurations to other parallel nodes.

Thus, in one embodiment, the present invention is directed to a system for on-line configuration management of a production environment having a plurality of target nodes, each of which has a current configuration of software controlling at least some of the functions of the node. The system includes a central configuration management server, a plurality of agents associated with the target nodes, and a central configuration database in communication with the central server. Each agent is installed on an associated target node to monitor the configuration of the software on the associated node and to report to the server, configuration changes detected by the agent. The central configuration database stores the configuration of the software as reported by the agents for the plurality of nodes.

In another embodiment, the present invention is directed to a method of on-line configuration management of a production environment having a plurality of target nodes, wherein each of the target nodes has a current configuration of software controlling at least some of the functions of the node. The method includes the steps of providing a central configuration management server; installing a plurality of agents on the target nodes, wherein each agent is installed on an associated target node and is in communication with the central server; and monitoring by each agent, the configuration of the software on the agent's associated node. Upon detecting a configuration change on a node, the associated agent sends a report of the configuration change to the central server. The central server then stores in a central configuration database, the configuration of the software as reported by the agents to the central server.

In yet another embodiment, the present invention is directed to a central configuration management server for on-line configuration management of a production environment having a plurality of target nodes, wherein each of the target nodes has a current configuration of software controlling at least some of the functions of the node, and each node has an associated agent to monitor the configuration of the software on the associated node. The central server includes communication means for receiving configuration information from the agents associated with the plurality of nodes; and means for storing the received configuration information in a central configuration database in communication with the central server.

### BRIEF DESCRIPTION OF THE SEVERAL VIEWS OF THE DRAWING

In the following section, the invention will be described with reference to exemplary embodiments illustrated in the figures, in which:

FIG. 1 is a simplified block diagram of an exemplary embodiment of the system of the present invention;

FIG. 2 is an illustrative drawing of a configuration graphical user interface (GUI) displaying a portion of a file structure from a target node;

FIG. 3 is a flow chart of an exemplary embodiment of the on-line configuration management method of the present invention;

FIG. 4 is a flow chart of an exemplary embodiment of a synchronization method performed by the present invention;

FIG. 5 is a flow chart of an exemplary embodiment of a partial synchronization method performed by the present invention; and

FIG. 6 is a flow chart of an exemplary embodiment of a tuning method performed by the present invention.

### DETAILED DESCRIPTION

The present invention is directed to an automatic on-Line CM tool for revision handling. In one embodiment, the tool keeps track of software and applications in large production and development environments. The present invention may also be described as a real-time CM tool or system utilized where there is a need to keep a number of connected systems up to date with changing situations.

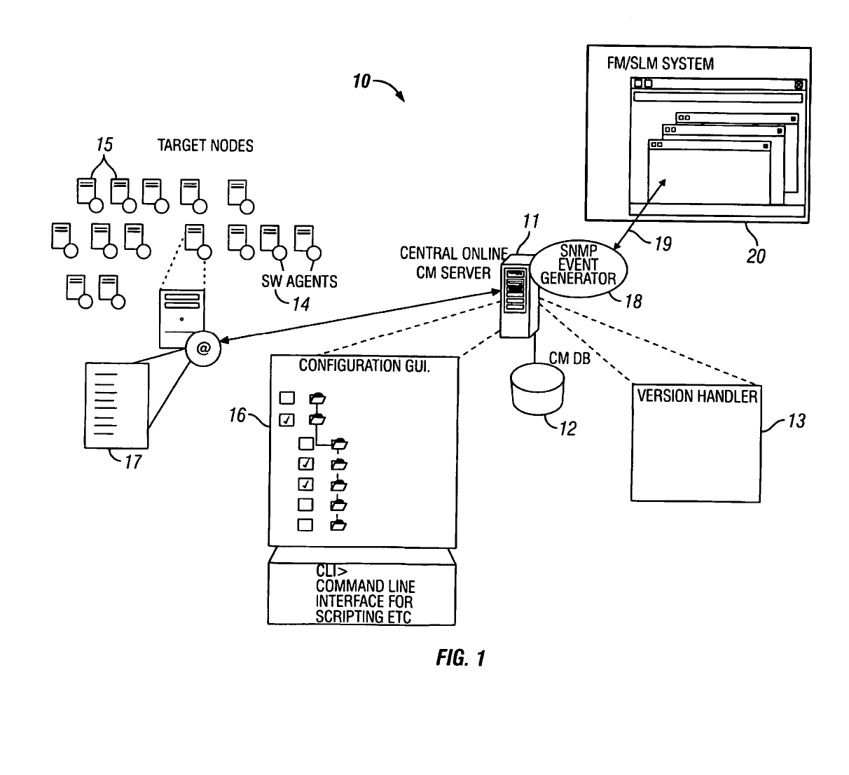

FIG. 1 is a simplified block diagram of an exemplary embodiment of the system 10 of the present invention. A central on-line CM server 11 controls the system and stores all monitored configuration files and binaries in a central CM database 12. A built-in version handler 13 manages the database files. The central CM server interacts with intelligent agents 14 that are installed on remotely monitored target nodes 15. Each agent is configurable from the central CM server through a configuration graphical user interface (GUI) 16 or by pre-configured scripts. Each agent keeps a local list 17 of the files to monitor. The agents, which normally run silently in the background, “wake up” when a change is detected, contact the central CM server 11, and upload the new version to the central CM database 12.

When agents detect and report changes, the central CM server 11 may utilize a Simplified Network Management Protocol (SNMP) event generator 18 to forward event notifications 19 to an external Fault Management (FM) and/or Service Level Management (SLM) system 20. This enables FM operators to correlate traffic disturbances to a specific configuration change detected in the production environment. The central CM server may also centrally push new configuration files to the remote target nodes 15, or revert to older versions in case disturbances are detected.

The present invention forces or helps maintenance personnel to follow a strict process-driven behavior without imposing the heavy load normally connected with traditional version handling.

The version handler 13 utilizes the configuration GUI 16 to present different file versions to maintenance personnel. The version handler contains a set of basic CM tools for file comparison (diff) and merging that can generate reports of the differences between target nodes or between current and older revisions of the files. Additionally, maintenance personnel can use the version handler to check out a file and work with the file off-line before it is checked in. The push functionality provides the ability to deploy the new file version remotely.

The intelligent agents 14 running on the remote target nodes 15 may be implemented in hardware, firmware, or preferably as small software modules that normally run in the background without interaction with the central CM server 11. This reduces the bandwidth needed and is one of the benefits with on-line CM compared to other solutions. In the preferred embodiment, the agents are configured remotely from the central CM server through the configuration GUI 16 or through a command tool where scripts and default configurations for initial setups can be performed. Each agent has a default configuration from startup where common OS and standard files are monitored.

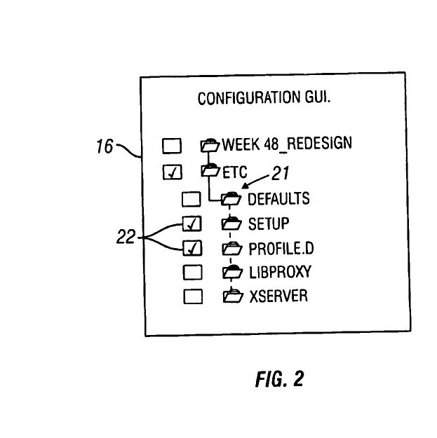

FIG. 2 is an illustrative drawing of the configuration GUI 16 displaying a portion of a file structure 21 from a target node 15. The configuration GUI may be built like a normal file browser capable of displaying the entire file structure from the target node. In one embodiment, maintenance personnel can select the files to monitor by clicking on tick boxes 22 in the configuration GUI. Maintenance personnel can also utilize the configuration GUI to further customize the agents 14. When changes are to be made to the target node or agent, the new configuration is downloaded to the agent's local file list 17 when the user is ready and has confirmed the changes. The configurations are also stored in the central CM database 12 and are controlled by the version handler 13.

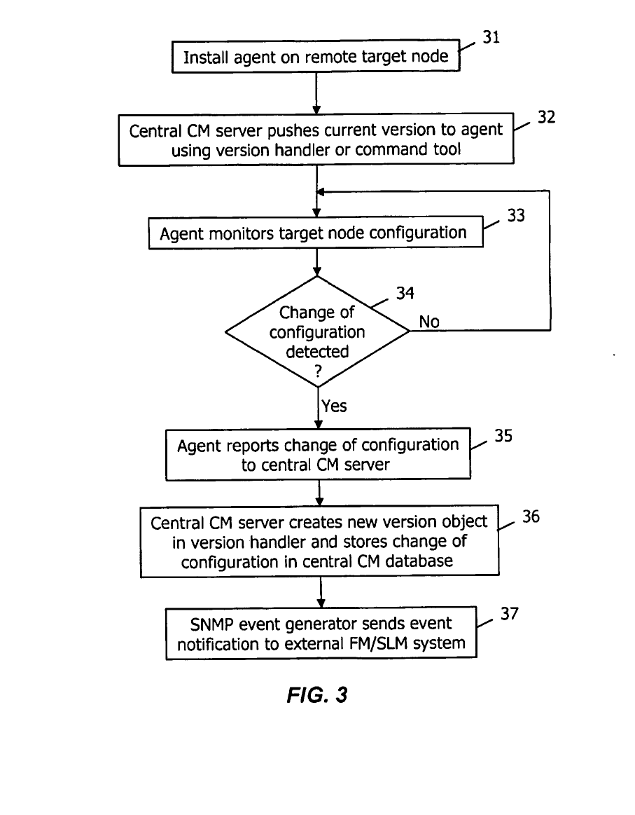

FIG. 3 is a flow chart of an exemplary embodiment of the on-line configuration management method of the present invention. Although FIG. 3 illustrates the method in the context of a single agent 14 and target node 15, it should be recognized that, in practice, the same process is performed between the central CM server 11 and a plurality of such agents. At step 31, the agent is installed on a remote target node. At optional step 32, the Central CM server pushes the current software version to the agent utilizing the version handler 13 or through a command tool. At step 33, the agent 14 monitors all files specified in the local copy of the agent configuration list 17. At step 34, the agent determines whether a change of configuration for the target node is detected. If not, the agent continues to operate in background mode, monitoring the target node's configuration at step 33. However, if the agent detects that a change of configuration for the target node has occurred (for example by detecting that a time-stamp has changed on any of the monitored files), the method moves to step 35 where the agent “wakes up” and contacts the central CM server 11. The new version of the file is uploaded to the central CM server. At step 36, the central CM server creates a new version object in the version handler 13 and stores the file in the central CM database 12.

In optional step 37, the central CM server may then forward an event notification 19 to the external FM/SLM system 20 for traceability. As noted above, the system of the present invention is equipped with an SNMP event generator 18 that forwards an event notification 19 to the external FM/SLM system if a configuration change is detected and reported by an agent 14. The notifications may include such information as a managed object identification, a target node identification, the configuration changes that have occurred, and the time of occurrence for each change. This feature is most valuable in live production environments where it enables possible operating disturbances to be correlated to specific changes on the target nodes 15.

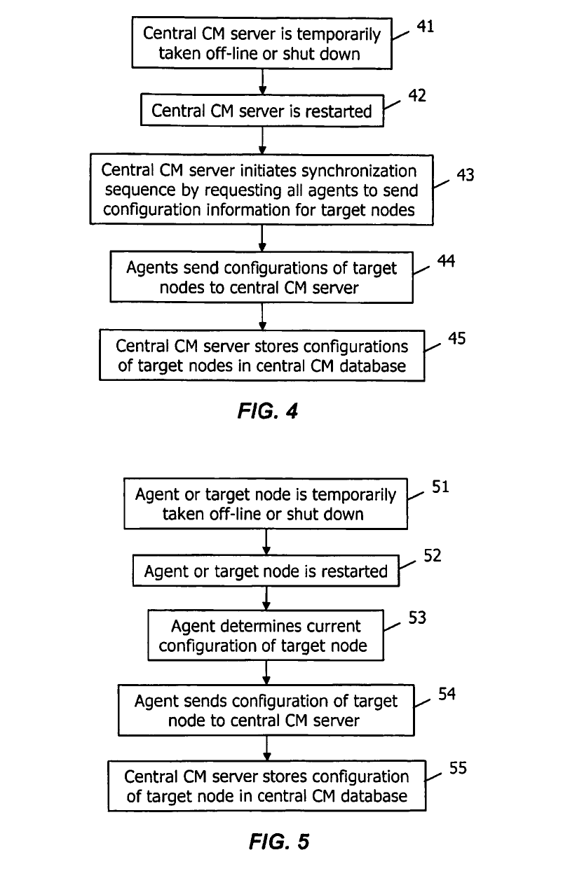

FIG. 4 is a flow chart of an exemplary embodiment of a synchronization method performed by the present invention, for example, when the central CM server 11 is restarted after a temporary shut down or off-line period. The purpose of the synchronization process is for all of the agents 14 to synchronize the configuration of their remote target nodes 15 with the central CM database 12. This synchronization process enables the system to register possible changes performed on the target nodes 15 during the time the central CM server was off-line. At step 41, the central CM server is temporarily shut down or taken off-line. At step 42, the central CM server is restarted. At step 43, the central CM server initiates a synchronization sequence by requesting all of the agents to send configuration information for their target nodes to the central CM server. At step 44, the agents send the configuration information for their target nodes to the central CM server. At step 45, the central CM server stores the configuration information for all of the target nodes in the central CM database.

FIG. 5 is a flow chart of an exemplary embodiment of a partial synchronization method performed by the present invention, for example, when an individual agent 14 or target node 15 is restarted after a temporary shut down or off-line period. The purpose of the partial synchronization process is for the individual agent to detect whether any new configuration changes were implemented during the off-line period, and to synchronize the current configuration of its target node 15 with the central CM database 12. At step 51, the individual agent or target node is temporarily shut down or taken off-line. At step 52, the individual agent or target node is restarted. At step 53, the agent determines the current configuration of its target node. At step 54, the agent sends the configuration information to the central CM server. At step 55, the central CM server stores the configuration information for the target node in the central CM database.

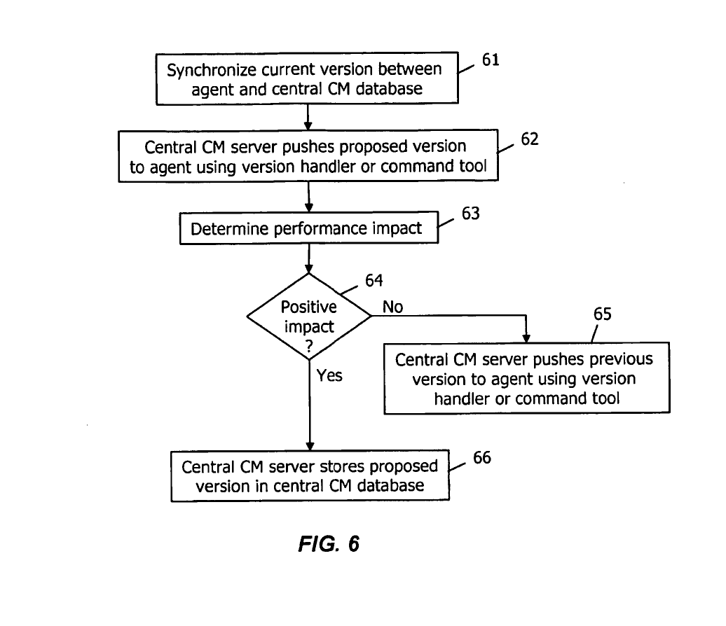

FIG. 6 is a flow chart of an exemplary embodiment of a tuning method performed by the present invention. The purpose of the tuning method is to test proposed configurations on the system or an individual node 15 to see how the new configuration performs. If a proposed configuration proves to be a mistake, the present invention enables the system or node to be easily reverted to an older version. At step 61, the method starts with the current version being synchronized between a node 15 and the central CM database 12. At step 62, the central CM server 11 pushes the proposed version to the node's agent 14 utilizing the version handler 13 or a command tool. At step 63, the performance impact of the proposed version is determined, for example, by a connected performance management tool or SLM system. At step 64, it is determined whether the performance impact is positive. If not, the method moves to step 65 where the central CM server 11 pushes the previous version back to the node. However, if the performance impact is positive, the change may be accepted. In this case, the central CM server stores the proposed version in the central CM database 12 as the new version for the node.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed is:

1. A system for on-line configuration management of a production environment having a plurality of target nodes, wherein each of the target nodes has a current configuration of software controlling at least some of the functions of the node, said system comprising:
a central configuration management server;
a plurality of agents in communication with the central server, wherein each agent is installed on an associated target node to monitor the configuration of the software on the associated node and to report configuration changes detected by the agent; and
a central configuration database in communication with the central server for storing the configuration of the software as reported by the agents for the plurality of nodes.

2. The system as recited in claim 1, further comprising a configuration graphical user interface (GUI) in communication with the central server and the central configuration database for displaying to an operator, a file structure of the software from each of the plurality of target nodes.

3. The system as recited in claim 2, wherein the central configuration database stores both current and past configurations for each of the plurality of nodes, and the system further comprises a version handler in communication with the database and the configuration GUI, wherein the version handler includes:
means for extracting different file versions from the database; and
means for utilizing the configuration GUI to display the different file versions to the operator.

4. The system as recited in claim 3, wherein the central server includes means for pushing new versions of software to the plurality of nodes.

5. The system as recited in claim 4, wherein the means for pushing new versions of software to the plurality of nodes includes means for utilizing the version handler to push the new versions of software to the plurality of nodes.

6. The system as recited in claim 4, wherein the means for pushing new versions of software to the plurality of nodes includes means for utilizing a command tool to push the new versions of software to the plurality of nodes.

7. The system as recited in claim 1, wherein the central server includes means responsive to a report of a configuration change for forwarding an event notification to an external fault management system.

8. The system as recited in claim 7, wherein the event notification includes a managed object identification, a target node identification, the configuration change that has occurred, and the time of occurrence of the change, thereby enabling any operating disturbances to be correlated to specific changes on the target nodes.

9. A method of on-line configuration management of a production environment having a plurality of target nodes, wherein each of the target nodes has a current configuration of software controlling at least some of the functions of the node, said method comprising the steps of:
providing a central configuration management server;
installing a plurality of agents on the target nodes, wherein each agent is installed on an associated target node and is in communication with the central server;
monitoring by each agent, the configuration of the software on the agent's associated node;
upon detecting a configuration change on an associated node, sending a report of the configuration change from the associated node's agent to the central server; and
storing in a central configuration database, the configuration of the software as reported by the agents to the central server.

10. The method as recited in claim 9, further comprising the server forwarding an event notification to an external fault management system, wherein the event notification includes a managed object identification, a target node identification, the configuration change that has occurred, and the time of occurrence of the change, thereby enabling any operating disturbances to be correlated to specific changes on the target nodes.

11. The method as recited in claim 9, further comprising the server pushing new versions of software to the plurality of nodes.

12. The method as recited in claim 9, further comprising the steps of:
restarting the central server after the central server has been off-line for a period of time;
sending a request from the central server to the plurality of agents requesting the agents to send configuration information for their target nodes;
receiving the configuration information in the central server; and
storing the configuration information in the central configuration database, thereby synchronizing the information in the agents with the information in the central configuration database.

13. The method as recited in claim 9, further comprising the steps of:
restarting a given node after the given node has been off-line for a period of time;
determining by the agent associated with the given node, the current configuration of the given node;
sending configuration information for the given node from the associated agent to the central server;
receiving the configuration information in the central server; and
storing the configuration information in the central configuration database, thereby synchronizing the information in the associated agent with the information in the central configuration database.

14. The method as recited in claim 9, further comprising the steps of:
pushing a proposed software version from the central server to a given node;
determining whether the proposed software version has improved the operation of the given node;
upon determining that the proposed software version has not improved the operation of the given node, pushing a previous software version from the central server to the given node; and
upon determining that the proposed software version has improved the operation of the given node, storing the proposed software version in the central configuration database as a new software version for the given node.

15. A central configuration management server for on-line configuration management of a production environment having a plurality of target nodes, wherein each of the target nodes has a current configuration of software controlling at least some of the functions of the node, and each node has an associated agent to monitor the configuration of the software on the associated node, said server comprising:
communication means for receiving configuration information from the agents associated with the plurality of nodes; and
means for storing the received configuration information in a central configuration database in communication with the central server.

16. The server as recited in claim 15, further comprising:
means for retrieving from the central configuration database, file structures of the software from each of the plurality of target nodes; and
a configuration graphical user interface (GUI) for displaying to an operator, file structures retrieved from the central configuration database.

17. The server as recited in claim 15, wherein the central configuration database stores both current and past configurations for each of the plurality of nodes, and the server further comprises a version handler in communication with the database and the configuration GUI, wherein the version handler includes:
means for extracting different file versions from the database; and
means for utilizing the configuration GUI to display the different file versions to the operator.

18. The server as recited in claim 15, further comprising means responsive to a report from an agent of a configuration change for forwarding an event notification to an external fault management system, wherein the event notification includes a managed object identification, a target node identification, the configuration change that has occurred, and the time of occurrence of the change, thereby enabling any operating disturbances to be correlated to specific changes on the target nodes.
